(19) United States
(12) Patent Application Publication
(10) Pub. No.: US 2011/0138185 A1
(43) Pub. Date: Jun. 9, 2011

(54) METHOD AND APPARATUS FOR UPDATING DATA

(75) Inventors: Hak-soo JU, Suwon-si (KR); Su-hyun NAM, Anyang-si (KR); Jeong-beom KIM, Suwon-si (KR); Eun-hwa HONG, Suwon-si (KR)

(73) Assignee: SAMSUNG ELECTRONICS CO., LTD., Suwon-si (KR)

(21) Appl. No.: 12/911,064

(22) Filed: Oct. 25, 2010

(30) Foreign Application Priority Data
Dec. 8, 2009 (KR) 10-2009-0121403

(51) Int. Cl. H04L 9/32; G06F 9/44; H04L 9/08

(52) U.S. Cl. 713/171; 717/168; 726/3; 717/173; 380/279

(57) ABSTRACT

A method and apparatus for updating data, the method including: receiving a forced update command to forcibly update at least one of a first digital rights management (DRM) module and a first device key stored in the device; receiving a DRM package including at least one of a second DRM module and a second device key based on the forced update command; and updating the at least one of the first DRM module and the first device key based on the received DRM package.

### CROSS-REFERENCE TO RELATED PATENT APPLICATION

This application claims priority from Korean Patent Application No. 10-2009-0121403, filed on Dec. 8, 2009 in the Korean Intellectual Property Office, the disclosure of which is incorporated herein in its entirety by reference.

### BACKGROUND

1. Field

Apparatuses and methods consistent with the exemplary embodiments relate to a method and apparatus for updating data in a device.

2. Description of the Related Art

A digital rights management (DRM) technique refers to a technique of preventing use of unauthorized digital contents in order to protect rights and profits of contents providers. Lately, many newly released digital contents are being protected by using a DRM technique and distributed.

In this case, a DRM module may be used to access contents to which a DRM technique has been applied. When a DRM module mounted in a device is employed for a long period of time, there may be a strong likelihood that the DRM module may be hacked by a third party. Accordingly, a method of updating a DRM module mounted in a device has been proposed.

### SUMMARY

Exemplary embodiments provide a method and apparatus for updating data in a device.

According to an aspect of an exemplary embodiment, there is provided a method of updating data in a device, the method including: receiving a forced update command to forcibly update at least one of a first digital rights management (DRM) module and a first device key stored in the device; receiving a DRM package including at least one of a second DRM module and a second device key based on the forced update command; and updating at least one of the first DRM module and the first device key based on the received DRM package.

The method may further include performing authentication between a first server from which the forced update command is received and the device.

Performing the authentication between the first server and the device may include: receiving a seed key from a second server; generating a token by using a shared key shared between the device and the second server and the seed key; generating a random number; generating a session key by using at least one of the random number, an identifier (ID) of the device, an ID of a model of the device, and a firmware version and the token; transmitting at least one of the random number, the ID of the device, the ID of the model of the device, and the firmware version to the first server; and performing authentication between the first server and the device by using the session key.

The first server may receive the token from the second server and generate the session key by using the at least one of the ID of the device, the ID of the model of the device, and the firmware version and the token.

The DRM package may further include data on at least one of an ID of the DRM package, a version of the DRM package, a type of data included in the DRM package, an additional description of the DRM package, a size of the DRM package, a uniform resource locator (URL) of a server to which a processing result of the DRM package is to be reported, a transmission path of the DRM package, a signature of the DRM package, and an encoding method used for the signature.

When the forced update command further includes connection data used for connecting with a server in which the DRM package is stored, the device may connect with the server and receive the DRM package based on the connection data.

The forced update command may be a command to forcibly update at least one of the first DRM module, the first device key, and a first application key used for an application stored in the device, the DRM package may further include a second application key, and the updating the at least one of the first DRM module and the first device key based on the received DRM package may include updating the first application key based on the received DRM package.

The method may further include transmitting an update list request to request an update list for the at least one of the first DRM module and the first device key, and the forced update command may be received in response to the update list request.

Receiving the DRM package may include: receiving a module package including the second DRM module; and receiving a key package including the second device key, wherein the module package and the key package may be received from different servers.

The method may further include determining whether the forced update is to be performed when the forced update command is received, and the DRM package may be selectively received based on the determination.

According to an aspect of another exemplary embodiment, there is provided an apparatus for updating data in a device, the apparatus including: a receiving unit which receives a forced update command to forcibly update at least one of a first DRM module and a first device key stored in the device and which receives a DRM package including at least one of a second DRM module and a second device key based on the forced update command; and an update unit which updates at least one of the first DRM module and the first device key based on the received DRM package.

The apparatus may further include an authentication unit which performs authentication between a first server configured to transmit the forced update command and the device.

The authentication unit may include: a token generator which generates a token by using a shared key shared with a second server and a seed key when the receiving unit receives the seed key from the second server; a random number generator which generates a random number; a key generator which generates a session key using the token and at least one of the random number, an ID of the device, an ID of a model of the device, and a firmware version; and an authentication performing unit which transmits at least one of the random number, an ID of the device, an ID of the model of the device, and the firmware version to the first server and which performs authentication between the first server and the device by using the session key. In this case, the first server may receive the token from the second server and generate the session key by using the token and at least one of the ID of the device, the ID of the model of the device, and the firmware version.

According to an aspect of another exemplary embodiment, there is provided a computer-readable medium having embodied thereon a computer program for executing a method including: receiving a forced update command to forcibly update at least one of a first DRM module and a first device key stored in the device; receiving a DRM package including at least one of a second DRM module and a second device key based on the forced update command; and updating the at least one of the first DRM module and the first device key based on the received DRM package.

According to an aspect of another exemplary embodiment, there is provided a method of transmitting update data to a device, the method including: transmitting, to the device, a forced update command to forcibly update at least one of a first digital rights management (DRM) module and a first device key stored in the device; and transmitting, to the device, a DRM package comprising at least one of a second DRM module and a second device key based on the forced update command, the DRM package being used in forcibly updating the at least one of the first DRM module and the first device key.

### BRIEF DESCRIPTION OF THE DRAWINGS

The above and other features and advantages will become more apparent by describing in detail exemplary embodiments thereof with reference to the attached drawings in which:

FIG. 1 is a flowchart illustrating a method of updating data in a device according to an exemplary embodiment;

FIG. 2 is a diagram of a structure of a digital rights management (DRM) package according to an exemplary embodiment;

FIG. 3 is a flowchart illustrating a method of updating data in a device according to another exemplary embodiment;

FIG. 4 is a diagram of an apparatus which updates data in a device according to an exemplary embodiment;

FIG. 5 is a diagram of an authentication unit according to an exemplary embodiment;

FIG. 6 is a flowchart illustrating a process through which a device may receive an update list from a server according to an exemplary embodiment;

FIG. 7 is a flowchart illustrating a process through which a device may receive an update list from a server as shown in FIG. 6 according to an exemplary embodiment, from a standpoint of a server;

FIG. 8 is a flowchart illustrating a method through which a device may receive a DRM package according to an exemplary embodiment; and

FIG. 9 is a flowchart illustrating a process of transmitting an update response command to a device of FIG. 8 according to an exemplary embodiment, from a standpoint of a server.

### DETAILED DESCRIPTION OF EXEMPLARY EMBODIMENTS

Exemplary embodiments will be described more fully hereinafter with reference to the accompanying drawings, in which like reference numerals refer to like elements throughout. Expressions such as “at least one of,” when preceding a list of elements, modify the entire list of elements and do not modify the individual elements of the list.

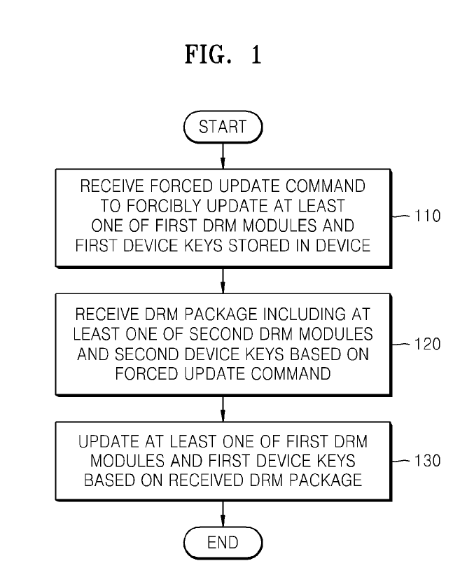

FIG. 1 is a flowchart illustrating a method of updating data in a device according to an exemplary embodiment. Referring to FIG. 1, in operation 110, a forced update command may be received by the device to forcibly update at least one first digital rights management (DRM) module stored in the device or at least one first device key stored in the device, or both thereof. Here, the first DRM modules and the first device keys may be referred to as DRM modules and device keys stored in the device.

In another exemplary embodiment, before the forced update command is received in operation 110, the device may transmit an update list request to a server to request an update list for the first DRM modules and the first device keys stored in the device. Here, the update list may be a list of IDs of first DRM modules and first device keys to be updated among the first DRM modules and the first device keys stored in the device.

For example, when the device transmits the update list request to the server, the server may transmit to the device the forced update command including the list of IDs of the first DRM modules and the first device keys to be forcibly updated among the first DRM modules and the first device keys stored in the device. In this case, the forced update command may be a command to forcibly update first DRM modules and first device keys, among the first DRM modules and the first device keys stored in the device. The first DRM modules and the first device keys to be forcibly updated may not fatally affect operations of the device when forcibly updated, but may be prioritized first DRM modules and first device keys among the first DRM modules and the first device keys stored in the device.

Also, the forced update command may further include connection data used for connecting with a server in which is stored a DRM package including second DRM modules and second device keys to be used to update the first DRM modules and the first device keys stored in the device. For example, the forced update command may include a uniform resource locator (URL) of the server in which the DRM package is stored. Here, the second DRM modules and the second device keys in the DRM package may be latest versions of DRM modules and device keys to be used to update the first DRM modules and the first device keys stored in the device.

Meanwhile, the forced update command may be received by the device based on the server's decision. For example, the server may be aware of versions of the first DRM modules and the first device keys stored in the device. In this case, the server may transmit the forced update command to the device after the server stores second DRM modules and second device keys having newer versions than the first DRM modules and the first device keys stored in the device or when the server recognizes that newer versions of the second DRM modules and the second device keys have been distributed. According to another exemplary embodiment, even if the server is unaware of the versions of the first DRM modules and the first device keys stored in the device, when the server recognizes that new versions of the second DRM modules and the second device keys have recently been distributed, the server may transmit the forced update command to the device without regards to the versions of the second DRM modules and the second device keys.

According to another exemplary embodiment, after the forced update command is received by the device, a process of determining whether a forced update is to be performed may further be performed. For example, when the forced update command is received, a message inquiring about whether the device is to perform the forced update may be output on a screen. In this case, the forced update may be performed when the user has determined that the forced update is to be performed, and the forced update may not be performed when the user has determined that the forced update is not to be performed.

In operation 120, a DRM package including at least one of the second DRM modules and the second device keys stored in the server may be received by the device based on the forced update command. In this case, one DRM package may include both at least one second DRM module and at least one second device key. In this case, by receiving one DRM package, at least one of the first DRM modules and at least one of the first device keys stored in the device may be updated.

However, according to another exemplary embodiment, one DRM package may include only at least one second DRM module or include only at least one second device key. In this case, one DRM package including only at least one second DRM module may be referred to as a module package, while one DRM package including only at least one second device key may be referred to as a key package. Also, one DRM package including both at least one second DRM module and at least one second device key may be referred to as a DRM package. Here, module packages and key packages in one DRM package may be received from one server or from different servers.

For example, when a server configured to manage a DRM module and a server configured to manage a device key are the same, both a module package and a key package may be received from one server. However, when the server configured to manage the DRM module and the server configured to manage the device key are different, the module package may be received from the server configured to manage the DRM module, while the key package may be received from the server configured to manage the device key.

Meanwhile, when the forced update command further includes the connection data used for connecting with the server in which the DRM package is stored in operation 110, the device may connect with the server based on the connection data and receive the DRM package.

For example, the forced update command may include a URL of a server configured to manage a DRM module, a URL of a server configured to manage a device key, and a URL of a server configured to manage a DRM package. The device may connect with the corresponding servers based on the respective URLs of the servers and receive the module package, the key package, and the DRM package managed by the servers.

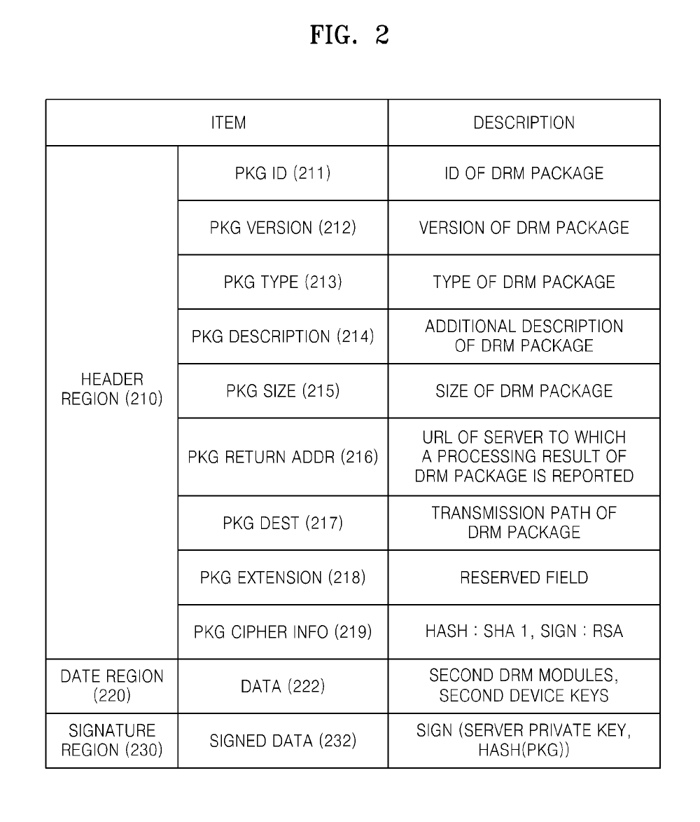

FIG. 2 is a diagram of a structure of a DRM package according to an exemplary embodiment. Referring to FIG. 2, the DRM package may include a header region 210, a data region 220, and a signature region 230.

The header region 210 may include nine fields 211 to 219. A package ID field 211 may indicate an ID of the DRM package.

A package version field 212 may indicate a version of the DRM package.

A package type field 213 may indicate a type of data included in the DRM package. For example, the package type field 213 may indicate whether the DRM package includes only at least one second DRM module, only at least one second device key, or both second DRM modules and second device keys. For example, 0X01 may indicate that the DRM package includes at least one second DRM module, 0X02 may indicate that the DRM package includes at least one second device key, both 0X01 and 0X02 or only 0X03 may indicate that the DRM package includes both at least one second DRM module and at least one second device key.

A package description field 214 may indicate at least one additional description about the DRM package. For example, the package description field 214 may include a name of the DRM package, data on an ID, name, and version of at least one second DRM module included in the DRM package, if any, and data on an ID of at least one second device key included in the DRM package, if any.

A package size field 215 may indicate an entire size of the DRM package.

A package return address field 216 may indicate a URL of a server to which a processing result of the DRM package is to be reported. For example, the processing result may be reported to the URL of the server included in the package return address field 216 that the device failed in receiving the DRM package, succeeded in receiving the DRM package, or finished updating based on the DRM package.

A package destination (or DEST) field 217 may indicate a transmission path of the DRM package. For example, when the DRM package is received through a plurality of servers, URLs of the respective servers may be written in the package destination field 217.

A package extension field 218 may be empty, for example, for future use.

A package cipher information field 219 may indicate an encoding method used in the signature region 230, which will be described later. For example, in the exemplary embodiment of FIG. 2, a SHA1 function is used as a hash function, and an RSA encoding method is used for a signature.

A data region 220 may include a data field 222. The data field 222 may include at least one second DRM module, at least one second device key, or both thereof. The at least one second DRM module and the at least one second device key stored in the data field 222 may be encoded and written by using a content key.

Meanwhile, according to another exemplary embodiment, the DRM package may additionally include at least one second application key. A second application key is a latest application key that may be used to update a corresponding first application key that may be used for at least one application stored in the device. For example, when the forced update command received by the device is a command to forcibly update the first DRM modules, the first device keys, and the first application keys stored in the device, the DRM package may include not only at least one second DRM module, and at least one second device key stored in the data field 222, but also second application keys.

The signature region 230 may include only a signed data field 232.

The signed data field 232 may apply a hash function to all data included in the header region 210 and the data region 220 and sign a hashed value with a private key of a server that has transmitted the DRM package to generate an electronic signature. In this case, as described with respect to the package cipher information field 219, a SHA1 function may be used as the hash function, and an RSA encoding method may be used for a signature.

In operation 130, at least one of the first DRM modules and the first device keys stored in the device may be updated based on the received DRM package. In an exemplary embodiment, the first DRM modules and the first device keys stored in the device may be forcibly updated in response to the forced update command so that the first DRM modules and the first device keys may be automatically updated before missing a time point when the first DRM modules and the first device keys stored in the device are to be updated. Thus, since the first DRM modules and the first device keys stored in the device are automatically updated, it becomes less likely that the first DRM module and the first device key stored in the device are hacked by a third party.

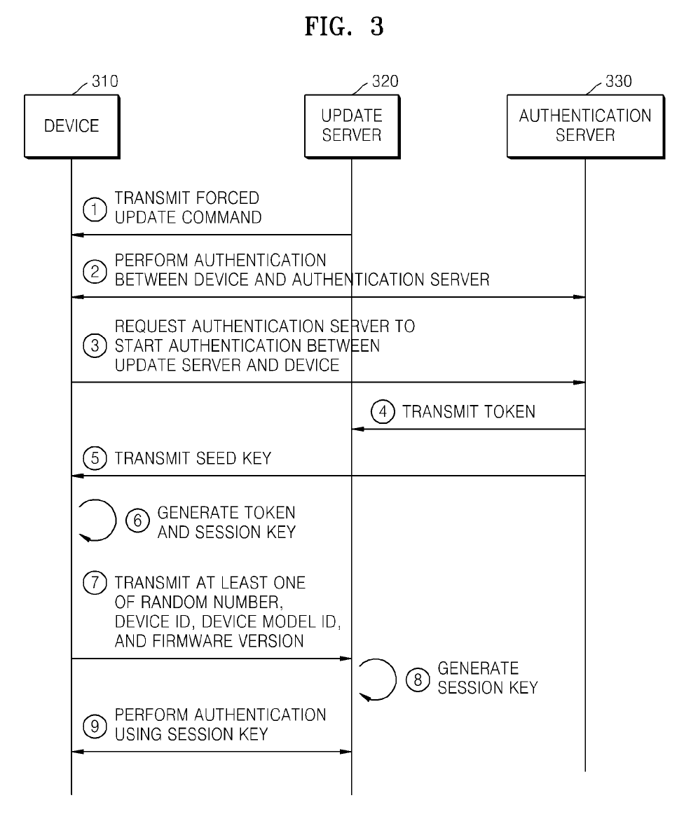

Meanwhile, according to another exemplary embodiment, before the DRM package is received, authentication between the server that has transmitted the forced update command and the device, which will receive the DRM package, may be performed first. When the authentication is successful, the device may receive the DRM package. Conversely, when the authentication has failed, the device may not receive the DRM package. Hereinafter, a process of performing authentication between the device and the server that has transmitted the forced update command will be described in detail with reference to FIG. 3.

FIG. 3 is a flowchart illustrating a method of updating data in a device according to another exemplary embodiment. Here, an update server 320 may be a server configured to manage DRM modules and device keys, and an authentication server 330 may be a server that may function to authenticate a device 310 and distribute applications. The update server 320 and the authentication server 330 may be different servers in one exemplary embodiment, and may be a same server in another exemplary embodiment.

Referring to FIG. 3, in step 1, an update server 320 may transmit a forced update command to the device 310 to forcibly update at least one of first DRM modules and first device keys stored in the device 310.

In step 2, authentication between the device 310 and the authentication server 330 may be performed. Since performing of authentication between a device and an authentication server is well known, a detailed description thereof will be omitted.

In step 3, after the authentication is successful in step 2, the device 310 may request the authentication server 330 to start authentication procedures between the device 310 and the update server 320.

In step 4, the authentication server 330, after being requested to start authentication procedures between the device 310 and the update server 320, may transmit a token to the update server 320.

In step 5, the authentication server 330 may transmit a seed key to the device 310. The seed key may be a random number generated by the authentication server 330.

In step 6, the device 310 may generate the token by using the seed key and a shared key shared with the authentication server 330 and may generate a session key by using the token. More specifically, after the device 310 generates the random number, the device 310 may generate the session key by using the random number, the token, an ID of the device 310, an ID of a model of the device 310, and a firmware version of the device.

The token may be obtained by substituting the shared key and the seed key into the SHA1 function, and the session key may be obtained by substituting the token and at least one of the random number, the ID of the device 310, the ID of the model of the device 310, and the firmware version of the device into a key derivation function (KDF). In this case, the KDF may be formed by using the SHA1 function and a pseudorandom number generator.

Here, the ID of the device 310 may refer to an intrinsic value used to identify the device 310, and the ID of the model of the device 310 may refer to an ID provided by a manufacturer of the device 310 to a product model to which the device 310 belongs. For example, when a digital television (DTV) manufacturer manufactures 10 different models of the device 310, a number of different IDs of the models of the device 310 may be 10, and a number of IDs that may correspond to the device 310 may be equal to a number of manufactured devices.

In step 7, the device 310 may transmit at least one of the random number generated by the device 310, the ID of the device 310, the ID of the model of the device 310, and the firmware version of the device to the update server 320.

In step 8, the update server 320 may generate the session key by using the at least one of the ID of the device 310, the ID of the model of the device 310, and the firmware version of the device, which are received from the device 310, and the token received from the authentication server 330. In this case, the update server 320 may not be aware of the seed key transmitted from the authentication server 330 to the device 310 and the shared key shared between the authentication server 330 and the device 310.

In step 9, the device 310 and the update server 320 may perform authentication by using the session key. In this case, the device 310 and the update server 320 may confirm whether respective session keys are the same to perform authentication between the device 310 and the update server 320.

According to an exemplary embodiment, the update server 320 may receive the token from the authentication server 330 and generate the session key. Thus, even if the update server 320 is unaware of the seed key or the shared key shared between the device 310 and the authentication server 330, the update server 320 may generate the session key so that the device 310 and the update server 320 may perform authentication. In a related art method, authentication between the device 310 and the authentication server 330 may be performed, while authentication between the device 310 and the update server 320 may not be performed. Accordingly, the update server 320 should transmit data to be transmitted to the device 310 through the authentication server 330. However, according to an exemplary embodiment, the device 310 and the update server 330 may directly transmit data therebetween through an authenticated safe channel.

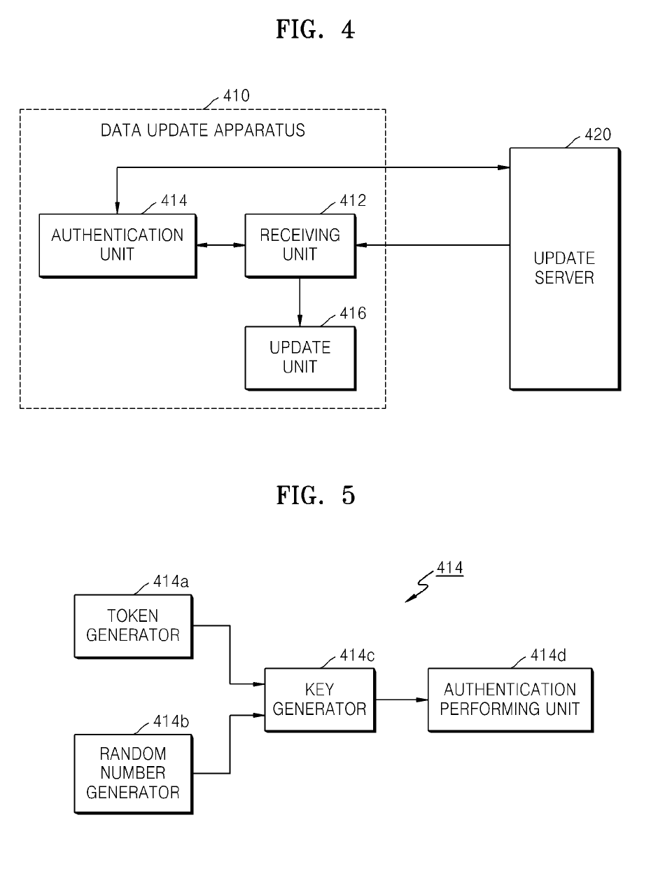

FIG. 4 is a diagram of an apparatus 410 which updates data in a device according to an exemplary embodiment. Referring to FIG. 4, a data update apparatus 410 may include a receiving unit 412, an authentication unit 414, and an update unit 416. In this case, it is assumed that the data update apparatus 410 is mounted in the device. Meanwhile, an update server 420 is further illustrated in FIG. 4 for clarity, but will not be described for brevity.

The receiving unit 412 may receive a forced update command from the update server 420 to forcibly update at least one first DRM module stored in the device or at least one first device key stored in the device, or both thereof. Also, the receiving unit 412 may receive a DRM package including at least one second DRM module or at least one second device key, or both thereof, from the update server 420 based on the forced update command.

The authentication unit 414 may perform authentication between the update server 240, which transmits the forced update command, and the device in which the data update apparatus 410 is mounted. In this case, when the authentication unit 414 determines that authentication between the update server 240 and the device has failed, the receiving unit 412 may not receive the DRM package from the update server 420. A detailed structure of the authentication unit 414 will be described later with reference to FIG. 5. Meanwhile, according to another exemplary embodiment, the authentication unit 414 may be omitted.

The update unit 416 may update at least one of the first DRM modules and the first device keys stored in the device based on the received DRM package through the receiving unit 412.

The data update apparatus 410 according to another exemplary embodiment may further include a transmission unit (not shown). When the receiving unit 412 receives the forced update command, the transmission unit may transmit a connection data request for requesting connection data used to connect with a server in which the DRM package is stored. Also, the transmission unit may further transmit an update list request to request an update list for the at least one first DRM module and the at least one first device key stored in the device.

Furthermore, the data update apparatus 410 according to another exemplary embodiment may further include a determination unit (not shown) which determines whether a forced update is to be performed when the receiving unit 412 receives the forced update command.

FIG. 5 is a diagram of an authentication unit 414 according to an exemplary embodiment. Referring to FIG. 5, the authentication unit 414 may include a token generator 414a, a random number generator 414b, a key generator 414c, and an authentication performing unit 414d.

When the receiving unit 412 receives a seed key from an authentication server, the token generator 414a may generate a token by using the seed key and a shared key shared with the authentication server.

The random number generator 414b may generate a random number.

The key generator 414c may generate a session key by using at least one of an ID of a device, an ID of a model of the device, a firmware version of the device, and the random number generated by the random number generator 414b and the token generated by the token generator 414a.

The authentication performing unit 414d may transmit the at least one of the random number, the ID of the device, the ID of the model of the device, and the firmware version of the device to the update server 420 and perform authentication between the update server 420 and the device by using the session key.

Meanwhile, a method of updating data in a device according to an exemplary embodiment may be embodied by transmitting and receiving a plurality of commands between the device and the server. Hereinafter, the method of updating data in the device according to the present exemplary embodiment will be described based on the commands transmitted and received between the device and the server.

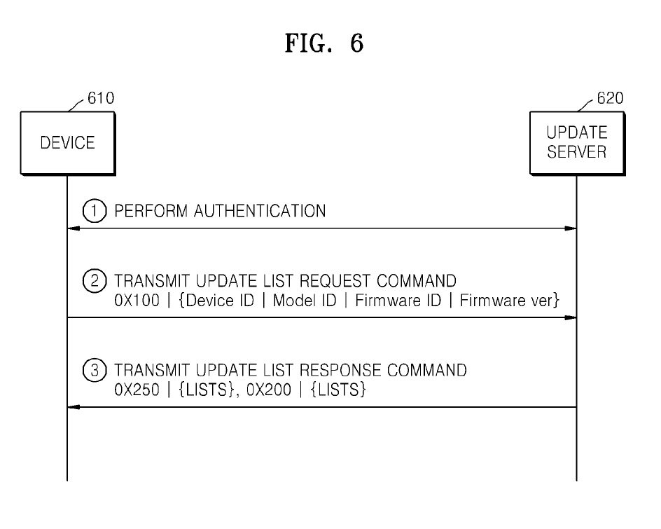

FIG. 6 is a flowchart illustrating a process through which a device may receive an update list from a server according to an exemplary embodiment.

In step 1, authentication between the device 610 and the update server 620 may be performed. For example, in step 1, the authentication may be performed based on whether the device 610 and the update server 620 have the same session key.

In step 2, when the authentication between the device 610 and the update server 620 is successful, the device 620 may transmit an update list request command to the update server 620 to request an update list for first DRM modules and first device keys stored in the device.

In FIG. 6, the device 610 may transmit 0x100|{Device ID|Model ID|Firmware ID|Firmware Ver} as the update list request command. Here, 0x100 may indicate that the currently transmitted command is a command to request the update list for the first DRM modules and the first device keys stored in the device. Model ID may indicate an ID of a model of the device, Firmware ID may indicate an ID of a firmware, and Firmware Ver may indicate a version of the firmware. According to an exemplary embodiment, it is assumed that any request command may have an ID starting with 0x1, any response command may have an ID starting with 0x2, and any error command may have an ID starting with 0x3, though it is understood that other exemplary embodiments are not limited thereto.

In step 3, the update server 630 may transmit an update list response command to the device 610 in response to the update list request command. Here, the update list response command may include a forced update command and an ordinary update command. The forced update command may be a command to forcibly update at least one first DRM module stored in the device or at least one first device key stored in the device 610, or both thereof. The ordinary update command may be a command to update at least one of the first DRM modules and the first device keys when decided by a user.

In the exemplary embodiment of FIG. 6, the update server 630 may transmit 0x250|{Lists} and 0x200|{Lists} as the update list response commands to the device 610. Here, 0x250|{Lists} may be a forced update command, while 0x200|{Lists} may be an ordinary update command. Furthermore, 0x250 may be an ID indicating that the currently transmitted command is a forced update command, and 0x200 may be an ID indicating that the currently transmitted command is an ordinary update command. Also, {Lists} included in each of the forced update command and the ordinary update command may refer to IDs of first DRM modules and IDs of first device keys to be forcibly updated. The IDs of the first DRM modules and the IDs of the first device keys to be forcibly updated may differ from the IDs of the first DRM modules and the IDs of the first device keys to be ordinarily updated.

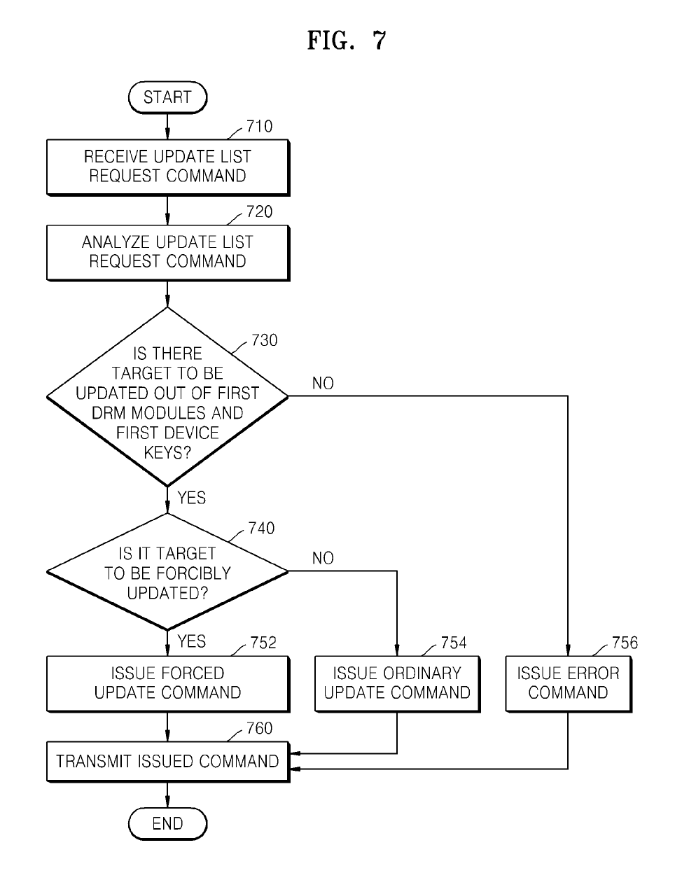

FIG. 7 is a flowchart illustrating a process through which the device 610 of FIG. 6 may receive an update list from a server from the standpoint of the server. Hereinafter, it is assumed that authentication between the update server 620 and the device 610 has already been performed by using the session key.

Referring to FIG. 7, in operation 710, the update server 620 may receive an update list request command from the device 610. In operation 720, the update server 620 may analyze the update list request command. More specifically, the update server 620 may estimate types of the first DRM modules and the first device keys stored in the device 610 based on at least one of an ID of the device 610, an ID of a model of the device 610, an ID of a firmware, and a firmware version, which are included in the update list request command received from the device 610.

In operation 730, the update server 620 may determine whether there is data to be updated out of the first DRM modules and the first device keys determined to be stored in the device 610 based on the analysis. In this case, the update server 620 may perform the determination operation 730 depending on whether the update server 620 retains the latest versions of second DRM modules and second device keys corresponding to the first DRM modules and the first device keys stored in the device or whether there is another server retaining the latest versions of the second DRM modules and the second device keys.

In operation 740, when it is determined that there is data to be updated among the first DRM modules and the first device keys stored in the device in operation 730, the update server 620 may determine whether the first DRM modules and the first device keys to be updated are to be forcibly updated. In this case, the update server 620 may receive a list of the first DRM modules and the first device keys to be forcibly updated and perform the determination operation 740 based on the list.

In operation 752, a forced update command may be issued to forcibly update the first DRM modules and the first device keys that are determined to be forcibly updated in operation 740. As described above, the forced update command may include an ID “0x250” in order to indicate that the issued command is a forced update command.

In operation 754, an ordinary update command may be issued to update the first DRM modules and the first device keys determined not to be forcibly updated in operation 740 when decided by a user. As described above, the ordinary update command may include an ID “0x200” in order to indicate that the issued command is an ordinary update command.

In operation 756, when it is determined that there is no data to be updated out of the first DRM modules and the first device keys stored in the device, an error command may be issued to notify that there is no data to be updated. In this case, the error command, for example, 0x300|{Null}, may be issued. Here, 0x300 may be an ID indicating the error command, and Null may indicate that there is no data to be transmitted.

In operation 760, a command issued in operation 752, 754, or 756 may be transmitted to the device 610.

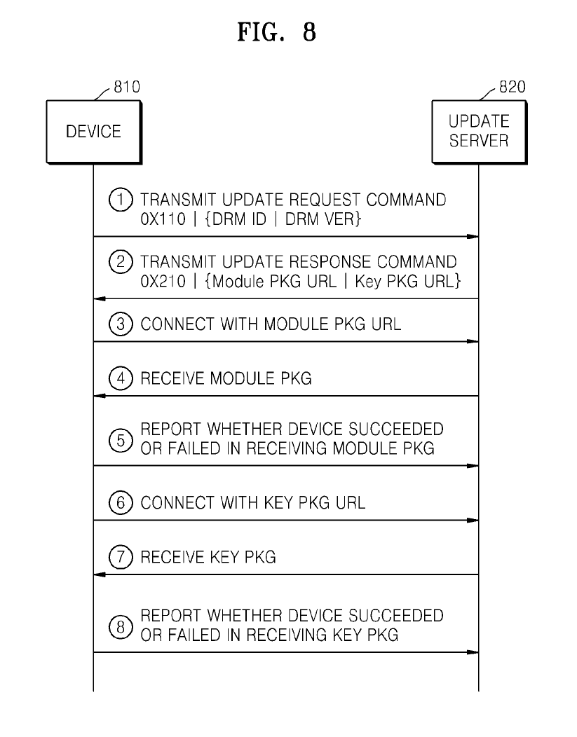

FIG. 8 is a flowchart illustrating a method through which a device may receive a DRM package according to an exemplary embodiment. Hereinafter, it is assumed that after authentication between a device 810 and an update server 820 has been performed, the device 810 has received an update list from the update server 820.

Referring to FIG. 8, in step 1, the device 810 may transmit an update request command to the update server 820 to update first DRM modules and first device keys stored in the device. For example, a user may select at least one first DRM module or at least one first device key, or both thereof, that are determined to be updated out of the update list received by the device 810 and allow the device 810 to transmit an update request command to update the selected first DRM modules and first device keys.

Referring to FIG. 8, 0x100|{DRM ID|DRM VER} may be transmitted as the update request command, though it is understood that another exemplary embodiment is not limited thereto. Here, 0x100 may be an ID indicating that the currently transmitted command is an update request command to update one first DRM module and one first device key. DRM ID may be an ID of the first DRM module to be updated out of the first DRM modules stored in the device. DRM VER may be a version number of the first DRM module. Although FIG. 8 illustrates that an ID of only one first DRM module is included in the update request command, IDs of a plurality of first DRMs to be updated or an ID of at least one device key to be updated may be included in the update request command in other exemplary embodiments.

For example, when the update request command includes 0x120, the update request command may be a request command to update only at least one first device key. When the update request command includes 0x130, the update request command may be a request command to update only one first DRM module. When the update request command includes 0x140, the update request command may be a request command to update a plurality of first DRM modules.

In step 2, the update server 820 may transmit an update response command corresponding to the update request command to the device 810. Referring to FIG. 8, the update server 820 may transmit 0x210|{Module PKG URL|Key PKG URL} as the update response command, though it is understood that another exemplary embodiment is not limited thereto. Here, 0x210 indicates that the currently transmitted command is a command to connect with a server in which a module package to be used to update the first DRM module is stored and a server in which a key package to be used to update the first device key is stored. Also, a Module PKG URL included in the update response command may be a URL of a server in which the module package is stored, and a Key PKG URL may be a URL of a server in which the key package is stored. However, according to another exemplary embodiment, the server configured to store the Module PKG may be the same as the server configured to store the Key PKG. In this case, only a URL of one server may be included in the update request command.

Meanwhile, although FIG. 8 illustrates that a single Module PKG URL and a single Key PKG URL are included in an update response command, only at least one Module PKG URLs may be included in the update response command or only at least one Key PKG URL may be included in the update response command in other exemplary embodiments.

For example, when the update response command includes 0x220, the update response command may include only at least one Key PKG URL in order to update only at least one first device key. When the update response command includes 0x230, the update response command may include only one Module PKG URL in order to update only one first DRM module. When the update response command includes 0x240, the update response command may include only a plurality of Module PKG URLs in order to update a plurality of first DRM modules. In this case, when the update response command includes 0x210 through 0x240, the device 810 may connect with a server corresponding to the Module PKG URL or Key PKG URL included in the update response command when decided by a user. However, when the update response command includes 0x250, the device 810 may forcibly connect with the server corresponding to the Module PKG URL or the server corresponding to the Key PKG URL irrespective of a user's option.

In step 3, the device 810 may connect with the PKG URL included in the update response command.

FIG. 8 illustrates that the device 810 connects with the update server 820. That is, in FIG. 8, it is assumed that the Module PKG URL corresponds to the update server 820. However, according to another exemplary embodiment, the Module PKG URL may correspond to a server other than the update server 820, and the device 810 may connect with the other server. Furthermore, although FIG. 8 illustrates that the device 810 connects to one Module PKG URL, when a plurality of Module PKG URLs are included in the update response command, the device 810 may connect to all of the plurality of URLs.

In step 4, the device 810 may receive a module package from a server corresponding to the Module PKG URL. FIG. 8 illustrates that the device 810 receives the module package from the update server 820. However, according to another exemplary embodiment, the device 810 may receive the module package from a server other than the update server 820. When a plurality of Module PKG URLs are included in the update response command, the device 810 may receive a plurality of module packages from respective servers corresponding to the plurality of Module PKG URLs.

In step 5, the device 810 may report whether the device 810 succeeds or fails in receiving the module package to a server corresponding to the Module PKG URL. FIG. 8 illustrates that the device 810 reports whether the device 810 succeeds or fails in receiving the module package to the update server 820. However, according to another exemplary embodiment, the device 810 may report the success or failure to a server other than the update server 820. When a plurality of Module PKG URLs are included in the update response command, the device 810 may report the success or failure to respective servers corresponding to the plurality of Module PKG URLs.

Meanwhile, when the update request command includes 0x130 or 0x140, the device 810 does not need to update the first device key, and thus the following steps 6 through 8 may be omitted.

In step 6, the device 810 may connect with the Key PKG URL included in the update response command. FIG. 8 illustrates that the device 810 connects with one Key PKG URL. However, when a plurality of Key PKG URLs are included in the update response command, the device 810 may connect with all of the plurality of Key PKG URLs. In this case, the Key PKG URL may be a URL of a server different from the Module PKG URL or a URL of the same server as with the Module PKG URL.

In step 7, the device 810 may receive the key package from the server corresponding to the Key PKG URL. FIG. 8 illustrates that the device 810 receives the key package from the update server 820. However, according to another exemplary embodiment, the update server 820 may receive the key package from a server other than the update server 820. When a plurality of Key PKG URLs are included in the update response command, the device 810 may receive a plurality of key packages from respective servers corresponding to the plurality of Key PKG URLs.

In step 8, it may be reported whether the device 810 succeeds or fails in receiving the key package to a server corresponding to the Key PKG URL. FIG. 8 illustrates that the device 810 reports whether the device 810 succeeds or fails in receiving the key package to the update server 820. However, according to another exemplary embodiment, the device 810 may report the success or failure to a server other than the update server 820. When a plurality of Key PKG URLs are included in the update response command, the device 810 may report the success or failure to respective servers corresponding to the plurality of Key PKG URLs.

Meanwhile, when the update request command includes 0x120, since the device 810 does not need to update the first DRM module, only steps 6 through 8 may be performed without performing steps 3 through 5.

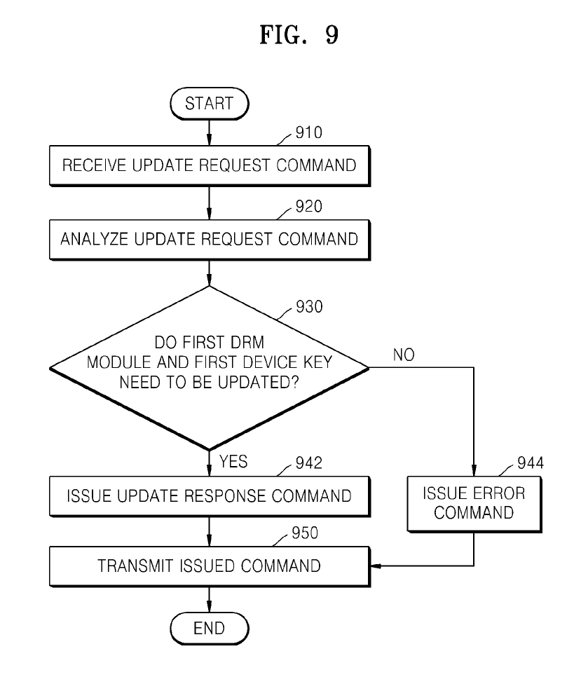

FIG. 9 is a flowchart illustrating a process of transmitting an update response command to the device of FIG. 8 from the standpoint of the server. Referring to FIG. 9, in step 910, the update server 820 may receive an update request command from the device 810.

In step 920, the update server 820 may analyze the update request command. More specifically, the update server 820 may analyze an update request command and read IDs of versions of at least one first DRM module included in the update request command and versions of the at least one first DRM module. When the update request command includes, for example, 0x120, the update server 820 may determine that the update request command is to update only at least one first device key. When the update request command includes, for example, 0x130, the update server 820 may determine that the update request command is to update only one first DRM module. When the update request command includes, for example, 0x140, the update server 820 may determine that the update request command is to update a plurality of first DRM modules.

In step 930, the update server 820 may determine whether the first DRM module and the first device keys are to be updated, based on the analysis. In this case, the update server 820 may perform the determination operation 930 based on whether the update server 820 retains the latest versions of second DRM modules and second device keys corresponding to the first DRM modules and the first device keys (stored in the device) or whether there is another server retaining the latest versions of the second DRM modules and the second device keys.

In operation 942, when it is determined in operation 930 that at least one of the first DRM modules and the first device keys is to be updated, the update server 820 may issue an update response command based on the analysis performed in operation 920. More specifically, the update server 820 may issue an update response command including 0x210, 0x220, 0x230, or 0x240 in response to the update request command. However, when it is determined based on the analysis performed in operation 920 that the first DRM modules and the first device keys included in the update request command are to be forcibly updated, the update server 820 may issue an update response command including 0x250.

In this case, when the update server 820 determines whether the first DRM modules and the first device keys included in the update request command are to be forcibly updated, the update server 820 may receive a list of the first DRM modules and the first device keys included in the update request command and perform the determination operation based on the list.

In operation 944, when it is determined that the first DRM modules and the first device keys are not to be updated, the update server 820 may issue an error command to notify the device 810 that there is no data to be updated.

In operation 950, the command issued in operation 942 or 944 may be transmitted to the device 810.

While not restricted thereto, exemplary embodiments can be written as computer programs and can be implemented in general-use digital computers that execute the programs using a computer readable recording medium. Examples of the computer readable recording medium include magnetic storage media (e.g., ROM, floppy disks, hard disks, etc.) and optical recording media (e.g., CD-ROMs, or DVDs). Also, exemplary embodiments may be written as computer programs transmitted over a computer-readable transmission medium, such as a carrier wave, and received and implemented in general-use digital computers that execute the programs. Moreover, while not required in all aspects, one or more of the above-described units can include a processor or microprocessor executing a computer program stored in a computer-readable medium.

While aspects have been particularly shown and described with reference to exemplary embodiments, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of exemplary embodiments, but by the appended claims, and all differences within the scope will be construed as being included in the present invention.

1. A method of updating data in a device, the method comprising:
receiving a forced update command to forcibly update at least one of a first digital rights management (DRM) module and a first device key stored in the device;
receiving a DRM package comprising at least one of a second DRM module and a second device key based on the forced update command; and
updating the at least one of the first DRM module and the first device key based on the received DRM package.

2. The method of claim 1, further comprising performing authentication between the device and a first server from which the forced update command is received.

3. The method of claim 2, wherein the performing the authentication between the device and the first server comprises:
receiving a seed key from a second server;
generating a token by using the seed key and a shared key shared between the device and the second server;
generating a random number;
generating a session key by using the token and at least one of the random number, an identifier (ID) of the device, an ID of a model of the device, and a firmware version;
transmitting the at least one of the random number, the ID of the device, the ID of the model of the device, and the firmware version to the first server; and
performing the authentication between the first server and the device by using the session key,
wherein the first server receives the token from the second server and generates the session key by using the token and the at least one of the ID of the device, the ID of the model of the device, and the firmware version.

4. The method of claim 1, wherein the DRM package further comprises data on at least one of an ID of the DRM package, a version of the DRM package, a type of data included in the DRM package, an additional description of the DRM package, a size of the DRM package, a uniform resource locator (URL) of a server to which a processing result of the DRM package is to be reported, a transmission path of the DRM package, a signature of the DRM package, and an encoding method used for the signature.

5. The method of claim 1, further comprising, when the forced update command comprises connection data used for connecting with a server in which the DRM package is stored, connecting to the server based on the connection data and receiving the DRM package.

6. The method of claim 1, wherein:
the forced update command is a command to forcibly update at least one of the first DRM module, the first device key, and a first application key used for an application stored in the device;
the DRM package further comprises a second application key; and
the updating the at least one of the first DRM module and the first device key based on the received DRM package comprises updating the first application key based on the received DRM package.

7. The method of claim 1, further comprising:
transmitting an update list request to request an update list for the at least one of the first DRM module and the first device key,
wherein the forced update command is received in response to the update list request.

8. The method of claim 1, wherein the receiving the DRM package comprises:
receiving, from a first server, a module package comprising the second DRM module; and
receiving, from a second server, a key package comprising the second device key,
wherein the first server is different from the second server.

9. The method of claim 1, further comprising:
determining whether a forced update is to be performed in response to the receiving the forced update command,
wherein the DRM package is selectively received based on the determining.

10. The method of claim 3, further comprising performing authentication between the device and the second server before the receiving the seed key from the second server.

11. An apparatus for updating data in a device, the apparatus comprising:
a receiving unit which receives a forced update command to forcibly update at least one of a first digital rights management (DRM) module and a first device key stored in the device and which receives a DRM package comprising at least one of a second DRM module and a second device key based on the forced update command; and
an update unit which updates the at least one of the first DRM module and the first device key based on the received DRM package.

12. The apparatus of claim 11, further comprising an authentication unit which performs authentication between the device and a first server from which the forced update command is received.

13. The apparatus of claim 12, wherein the authentication unit comprises:
a token generator which generates a token by using a shared key shared between the device and a second server and a seed key received by the receiving unit from the second server;
a random number generator which generates a random number;
a key generator which generates a session key by using the token and at least one of the random number, an identifier (ID) of the device, an ID of a model of the device, and a firmware version; and
an authentication performing unit which transmits the at least one of the random number, the ID of the device, the ID of the model of the device, and the firmware version to the first server and which performs the authentication between the first server and the device by using the session key,
wherein the first server receives the token from the second server and generates the session key by using the token and the at least one of the ID of the device, the ID of the model of the device, and the firmware version.

14. The apparatus of claim 11, wherein the DRM package further comprises data on at least one of an ID of the DRM package, a version of the DRM package, a type of data included in the DRM package, an additional description of the DRM package, a size of the DRM package, a uniform resource locator (URL) of a server to which a processing result of the DRM package is to be reported, a transmission path of the DRM package, a signature of the DRM package, and an encoding method used for the signature.

15. The apparatus of claim 11, further comprising a communication unit which, when the forced update command comprises connection data used for connecting a server in which the DRM package is stored, a connects with the server based on the connection data,
wherein the receiving unit receives the DRM package from the server.

16. The apparatus of claim 11, wherein:
the forced update command is a command to forcibly update at least one of the first DRM module, the first device key, and a first application key used for an application stored in the device;
the DRM package further comprises a second application keys; and
the update unit updates the first application key based on the received DRM package.

17. The apparatus of claim 11, further comprising:
a transmission unit which transmits an update list request to request an update list for the at least one of the first DRM module and the first device key,
wherein the forced update command is received in response to the update list request.

18. The apparatus of claim 11, wherein the receiving unit receives, from a first server, a module package comprising the second DRM module and receives, from a second server different from the first server, a key package comprising the second device key.

19. The apparatus of claim 11, further comprising:
a determination unit which determines whether a forced update is to be performed in response to the received forced update command,
wherein the DRM package is selectively received based on the determination.

20. A computer-readable medium having embodied thereon a computer program for executing the method of claim 1.

21. A method of transmitting update data to a device, the method comprising:
transmitting, to the device, a forced update command to forcibly update at least one of a first digital rights management (DRM) module and a first device key stored in the device; and
transmitting, to the device, a DRM package comprising at least one of a second DRM module and a second device key based on the forced update command, the DRM package being used in forcibly updating the at least one of the first DRM module and the first device key.

22. The method of claim 21, further comprising:
receiving, from the device, an update list request for requesting an update list for the at least one of the first DRM module and the first device key,
wherein the transmitting the forced update command comprises transmitting the forced update command in response to the received update list request.

23. The method of claim 22, wherein the transmitting the forced update command in response to the received update list request comprises:
determining whether the at least one of the first DRM module and the first device key are to be forcibly updated;
transmitting the forced update command in response to determining that the at least one of the first DRM module and the first device key are to be forcibly updated; and
transmitting a non-forced update command in response to determining that the at least one of the first DRM module and the first device key are not to be forcibly updated.

24. A computer-readable medium having embodied thereon a computer program for executing the method of claim 21.
